(19) United States
(12) Patent Application Publication
(10) Pub. No.: US 2008/0097059 A1
(43) Pub. Date: Apr. 24, 2008

(54) Resin composition for making loudspeaker cone

(75) Inventors: Wen-Shyang Hsu, Taoyuan Hsien (TW); Hiroshi Ohara, Taoyuan Hsien (TW)

Correspondence Address: BIRCH STEWART KOLASCH & BIRCH, PO BOX 747, FALLS CHURCH, VA, 22040-0747, US

(73) Assignee: Chan Sieh Enterprises Co., Ltd., Hiroshi Ohara

(21) Appl. No.: 11/583,919

(22) Filed: Oct. 20, 2006

(51) Int. Cl. C08F 4/00

(52) U.S. Cl. 526/225; 526/319; 526/286; 526/318.43

(57) ABSTRACT

A resin composition for making a loudspeaker cone, including from 50 to 99.9 weight parts of an alkyl acrylate (A) represented by the following formula (I), from 0.1 to 50 weight parts of a vinyl unsaturated monomer (B), and an emulsifying agent (C) present in an amount of from 0.1 to 10 weight parts based on the combined weight parts of (A) and (B),

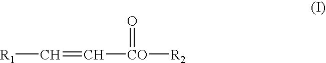

wherein R₁ represents a hydrogen atom, or a C₁-C₁₂ linear or branched alkyl group, alkenyl group, alkynyl group or alcoholic group, and R₂ represents a hydrogen atom, or a C₁-C₃ linear or branched alkyl group.

### BACKGROUND OF THE INVENTION

1. Field of the Invention

The present invention relates to a resin composition for making a loudspeaker cone, and more particularly to a resin composition containing no toxic aldehyde compounds, and thereby the toxicity hazard occurred during the process for making a loudspeaker cone can be reduced.

2. The Prior Arts

A typical loudspeaker cone is a paper cone located around the exterior edge of the loudspeaker frame, and is made by impregnating a substrate (such as paper or cloth) with a resin or by coating a substrate with a resin, followed by drying to remove the solvent and then thermoforming to obtain a loudspeaker cone.

A phenolic resin made by polymerizing a phenol with an aldehyde is usually used for impregnating the substrate of the loudspeaker cone. However, the phenols or the aldehydes are harmful to the environment and human health because they are toxic. Therefore, if the loudspeaker cone is made from the phenolic resin, there always exists a problem of the aldehyde residue (such as formaldehyde) which is harmful to the environment and human health.

To overcome the problem of the toxic aldehydes remained on the loudspeaker cone made from the phenolic resin, attempts have been made to manufacture a loudspeaker cone from a substituent material which will not cause the problem of the toxic compound residue.

### SUMMARY OF THE INVENTION

To solve the above-mentioned problems, it is an objective of the present invention to provide a resin composition for making a loudspeaker cone, which will not cause the problem of the toxic compound residue on the loudspeaker cone.

To achieve the foregoing objective, the present invention provides a resin composition for making a loudspeaker cone, which comprises from 50 to 99.9 weight parts of an alkyl acrylate (A) represented by the following formula (I), from 0.1 to 50 weight parts of a vinyl unsaturated monomer (B), and an emulsifying agent (C) present in an amount of from 0.1 to 10 weight parts based on the combined weight parts of (A) and (B),

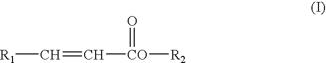

wherein R₁ represents a hydrogen atom, or a C₁-C₁₂ linear or branched alkyl group, alkenyl group, alkynyl group or alcoholic group, and R₂ represents a hydrogen atom, or a C₁-C₃ linear or branched alkyl group.

In order to enhance the strength of the loudspeaker cone made from the resin composition of the present invention, the resin composition can further comprises an intramolecular cross-linker (D) which can cross-link the resin so that the glass transition temperature, heat-resistance, and water-proof of the resin composition of the present invention can be increased. The intramolecular cross-linker (D) is present in an amount of from 0.01 to 10 weight parts based on the combined weight parts of (A), (B) and (D).

These and other objectives and functions of the present invention will be apparent to those skilled in the art by reading the following detailed description of a preferred embodiment thereof.

### DETAILED DESCRIPTION OF THE PREFERRED EMBODIMENT

In the present invention, the resin composition for making a loudspeaker cone at least comprises an alkyl acrylate A represented by the following formula (I), a vinyl unsaturated monomer (B), and an emulsifying agent (C),

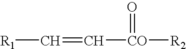

wherein R₁ represents a hydrogen atom, or a C₁-C₁₂ linear or branched alkyl group, alkenyl group, alkynyl group or alcoholic group, and R₂ represents a hydrogen atom, or a C₁-C₃ linear or branched alkyl group.

Examples of the alkyl acrylate (A) include, but not limited to, methyl acrylate, ethyl acrylate, propyl acrylate, isopropyl acrylate, butyl acrylate, isobutyl acrylate, hexyl acrylate, octyl acrylate, 2-ethyl hexyl acrylate, and methyl methacrylate.

The vinyl unsaturated monomer (B) is a monomer having a vinyl group, and a functional group selected from the group consisting of a carboxyl group, a hydroxy group, a methylol group, an amino group, an amide group, a glycidyl, a phosphoric group, a sulfonic group, an ethylene imine group, and an isocyanate group. Examples of the vinyl unsaturated monomer (B) include, but not limited to, vinyl carboxylic acid, such as acrylic acid, methyl acrylate, maleic anhydride, maleic acid, maleic acid n-ester, and crotonic acid; vinyl unsaturated monomer, such as 2-hydroxyethyl methacrylate, 2-hydroxypropyl methacrylate, polyethylene glycol acrylate, N-methyl amino ethylacrylate, N-tributyl amino ethylacrylate, N, N-dimethyl amino ethylacrylate, N, N-dimethyl amino ethylmethacrylate, N, N-diethyl amino ethylmethacrylate, acrylamide, methacrylamide, and vinylpyrrolidone; and vinyl monomer, such as vinylester, vinylpyridien, acrylonitrile, methacrylonitrile, vinyl acetate, vinyl propionic acid, and styrene.

The emulsifying agent (C) employed in the present invention may be any emulsifying agent that is capable of emulsifying the alkyl acrylate (A) and the vinyl unsaturated monomer (B) in the presence of water. The emulsifying agent employed in the present invention may be a reactive emulsifying agent, or a non-reactive emulsifying agent. Examples of the reactive emulsifying agent include, but not limited to, the emulsifying agent represented by the following formulae (II), (III), (IV), and (V):

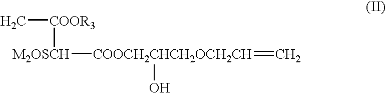

### (The product is Latemul S-180 produced by Kao Corporation in Japan, wherein R₃ represents a C₁₂-C₁₈alkyl group, and M represents Na or NH₄).

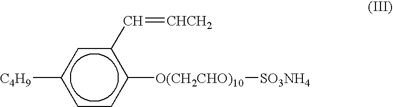

(The product is Hitenol HS-10 produced by Daiichi Seiyaku Co. Ltd. in Japan).

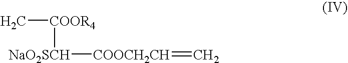

### (The product is JS-2 produced by Sanyo kasei Co., Ltd. in Japan, wherein R₄ represents a C₁₂-C₁₈alkyl group).

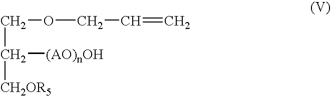

(the production of Asahi Denka Co., Ltd. in Japan, wherein R₅ represents an alkyl group, and AO represents alkyl oxide).

The non-reactive emulsifying agent can be anionic or nonionic emulsifying agent. Examples of the anionic emulsifying agent include, but not limited to, potassium oleate, sodium laurylsulfate, sodium dodecyl benzenesulfonate, sodium alkylnaphthalene sulfonate, sodium dialkyl sulfonate, sodium polyoxyethylene alkyl ether sulfate, sodium polyoxyethylene alkyl allyl ether sulfate, polyoxyethylene alkyl ether phosphate ester, and polyoxyethylene alkyl allyl ether phosphate ester.

Examples of the nonionic emulsifying agent include, but not limited to, polyoxyethylene alkyl ether, polyoxyethylene alkyl allyl ether, polyoxyethylene polyoxypropylene block copolymer, polyoxyethylene glycol fatty acid ester, polyoxyethylene sorbitan fatty acid ester.

In the resin composition of the present invention, the alkyl acrylate (A) represented by the following formula (I) is present in an amount of from 50 to 99.9 weight parts based on the combined weight parts of (A) and (B), the vinyl unsaturated monomer (B) is present in an amount of from 0.1 to 50 parts based on the combined weight parts of (A) and (B), and the emulsifying agent (C) is present in an amount of from 0.1 to 10 weight parts based on the combined weight parts of (A) and (B).

In order to enhance the strength of the loudspeaker cone made from the resin composition of the present invention, the resin composition of the present invention can further comprises an intramolecular cross-linker (D) which can cross-link the resin so that the glass transition temperature, heat-resistance, and water-proof of the resin composition of the present invention can be increased. The intramolecular cross-linker (D) is present in an amount of from 0.01 to 10 weight parts based on the combined weight parts of (A), (B) and (D). If the intramolecular cross-linker (D) is present in the resin composition of the present invention, the emulsifying agent (C) is present in an amount of from 0.1 to 10 weight parts based on the combined weight parts of (A), (B) and (D).

Examples of the intramolecular cross-linker (D) include, but not limited to, divinylbenzene, diethylene glycol dimethacrylate, and dipropylene glycol dimethacrylate.

If the physical properties of the resin composition of the present invention still can not meet the requirement of processing after adding the intramolecular cross-linker (D), another cross-linker (E) may be added to the resin composition to induce the excess functional groups on the monomers to undergo cross-linking so that the physical properties of the resin composition of the present invention can be further enhanced. The amount of the cross-linker (E) is not especially limited, but preferably 0.1 to 10 weight parts based on the combined weight parts of (A), (B), (C), and (D).

The cross-linker (E) employed in the present invention may be a compound having an epoxy group, an oxazoline group, or an isocyanate group. Examples of the compound having an epoxy group include, but not limited to. aliphatic oxide, glycidyl ether, glycidyl amine (such as “TETRAD™” series produced by Mitsubishi Gas Chemical Co., Inc.), and polyglycidyl ether (such as “TENAKOR™” series produced by Nagase Co., Ltd.). Among them, the glycidyl amine has the highest reactivity. Examples of the aliphatic oxide include, but not limited to, propylene oxide. Examples of the glycidyl ether include, but not limited to, aliphatic glycidyl ether such as butyl glycidyl ether (such as Epolight M-1230 produced by Kyoeisha Olechemical industrial Co.); aromatic glycidyl ether such as phenyl glycidyl ether; and glycidyl methacrylate. Examples of the compound having an oxazoline group include, but not limited to, aliphatic oxazoline such as 2-methyl oxazoline; aromatic oxazoline such as 2-phenyl oxazoline; 2-isopropyl-2-oxazoline; and oxazoline having unsaturated functional groups such as “Epocros™” series produced by NIPPON SHOKUBAI Co., Ltd. Examples of the compound having an an isocyanate group include, but not limited to, block Polyisocyanate produced by Sumika Bayer Urethane Co. Ltd.; aqueous block isocyanate dispersion of “Elastron™” and “Elastron BN™” series produced by Daiichi Seiyaku Co. Ltd.; and the compound having a carbodiimide group such as “Carbodilate™” series produced by Nisshinbo Industries Inc., or “Ucarink™ XL-29SE” produced by UNION CARBIDE.

During the preparation of the resin composition of the present invention, a polymerization initiator which initiate the polymerization of the monomers should be used. The polymerization initiator employed in the present invention is not especially limited as long as it can initiate the polymerization of the monomers, but the polymerization initiator is preferably a free radical initiator in consideration of the convenience of the process for making a loudspeaker cone. The free radicals can be produced from the free radical initiators in the presence of the reducing agents or upon heating. Examples of the free radical initiator include persulfate, peroxide, and azo compound, and the specific examples of the free radical initiator include, but not limited to, potassium persulfate, sodium persulfate, ammonium persulfate, hydrogen peroxide, t-butyl hydroperoxide, t-butyl peroxybenzoate, 2,2-azo-bis-isobutyronitrile, 2,2-azobis (2-diaminopropane) hydrochloride, 2,2-azobis (2,4-dimethyl-valeronitrile).

The polymerization initiator employed in the present invention is preferably water-soluble because water is used as a solvent for the resin composition of the present invention. A polymerization initiator can be used with a suitable reducing agent to enhance the polymerization rate. Examples of the suitable reducing agent include, but not limited to, sodium bisulfite, iron (III) chloride, and vitamin C.

The resin composition of the present invention can further comprises a molecular weight adjusting agent. Examples of the molecular weight adjusting agent include, but not limited to, butylmercaptan, dodecylmercaptan, thioglycol, propyl thioglycolate, octyl thioglycolate, isopropanol, methanol, and carbon tetrachloride.

The aldehyde compounds are usually used to dissolve the phenolic resin for making the loudspeaker cones. Instead of the aldehyde compounds, water is selected as the solvent to dissolve the resin composition of the present invention for making the loudspeaker cones. Therefore, if the resin composition of the present invention is used for making the loudspeaker cones, the toxicity hazard caused by using the phenolic resin can be reduced. Moreover, because water instead of the aldehyde compound is used as a solvent for dissolving the resin composition of the present invention so that the toxic aldehyde (such as formaldehyde ) will not be left on the loudspeaker cone.

The resin composition of the present invention will be further described below by way of the synthesis examples as well as the working examples thereof.

### SYNTHESIS EXAMPLE 1

137.8 weight parts of water is added to a reaction vessel. 80 weight parts of methyl methacrylate, 6.2 weight parts of methyl acrylate, 1 weight parts of acrylic acid, and 0.1 weight parts of divinylbenzene are added to another reaction vessel and are well mixed together, and then the reactive anionic emulsifying agent/anionic emulsifying agent (1.5 weight parts/0.5 weight parts, calculated by monomer) are added thereto in order to obtain a monomer pre-emulsion.

The nitrogen gas is allowed to enter the reaction vessel containing water which is heated to 75° C., and then 0.05 weight parts of ammonium persulfate as a polymerization initiator is added thereto, and subsequently the monomer pre-emulsion is slowly dropped therein over a period of 3 hours. Then, an additional 1 wt. % of ammonium persulfate is dropped in this reaction vessel over a period of 3.5 hours while the monomer pre-emulsion is slowly dropped therein. After the addition of the polymerization initiator, this reaction vessel is kept at 80° C. for 2hours and then cooled down to temperatures below 30° C., followed by adding 25 wt. % of ammonium water to obtain a 40 wt. % polymer emulsion having viscosity of 100 cps and pH of 7.8 (herein is called “EM-1”).

### SYNTHESIS EXAMPLE 2

Except that 1 weight parts of the reactive anionic emulsifying agent and 0.5 weight parts of anionic emulsifying agent are used in place of 1.5 weight parts of he reactive anionic emulsifying agent and 0.5 weight parts of anionic emulsifying agent (calculated by monomer), the polymer emulsion is obtained in the same way as SYNTHESIS EXAMPLE 1 (herein is called “EM-2”).

### SYNTHESIS EXAMPLE 3

Except that 1 weight parts of the reactive anionic emulsifying agent and 1 weight parts of anionic emulsifying agent are used in place of 1.5 weight parts of he reactive anionic emulsifying agent and 0.5 weight parts of anionic emulsifying agent (calculated by monomer), the polymer emulsion is obtained in the same way as SYNTHESIS EXAMPLE 1 (herein is called “EM-3”).

### EXAMPLE 1

1 weight parts of Tetrad C (glycidyl amine), polyglycidyl ethers or oxazolines as a cross-linker is added to 100 weight parts of EM-1, followed by well stirring to obtain a “process liquid-1”.

A substrate for making a loudspeaker cone (such as polyester substrate) is impregnated in the “process liquid-1” and coated with it, and then the substrate is taken out from the “process liquid-1”. Afterwards, the “process liquid-1” is removed from the substrate by squeezing using a roller, and then the substrate is dried at 40° C. and molded by a hot press machine at 180° C. (i.e. thermal forming process) to obtain a loudspeaker cone.

### EXAMPLE 2

Except that the substrate is dried at 106° C. after the “process liquid-1” was removed from the substrate using a roller, and the dried substrate is molded by a cold press machine at 150° C. (i.e. cold forming process), the loudspeaker cone is produced in the same way as EXAMPLE 1.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claiemd is:

1. A resin composition for making a loudspeaker cone, comprising 50 to 99.9 weight parts of an alkyl acrylate represented by the following formula (I), from 0.1 to 50 weight parts of a vinyl unsaturated monomer, and an emulsifying agent present in an amount of from 0.1 to 10 weight parts based on the combined weight parts of the alkyl acrylate and the vinyl unsaturated monomer, 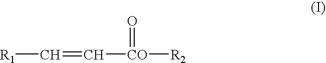
wherein R₁ represents a hydrogen atom, or a C₁-C₁₂ linear or branched alkyl group, alkenyl group, alkynyl group or alcoholic group, and R₂ represents a hydrogen atom, or a C₁-C₃ linear or branched alkyl group.

2. The resin composition as claimed in claim 1, wherein the vinyl unsaturated monomer has a functional group selected from the group consisting of a carboxyl group, a hydroxy group, a methylol group, an amino group, an amide group, a glycidyl, a phosphoric group, a sulfonic group, an ethylene imine group, and an isocyanate group.

3. The resin composition as claimed in claim 1, wherein the emulsifying agent is a reactive emulsifying agent.

4. The resin composition as claimed in claim 3, wherein the reactive emulsifying agent is represented by one of the following formulae (II), (III), (IV), and (V): 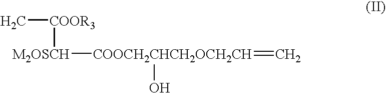
wherein R₃ represents a C₁₂-C₁₈alkyl group, and M represents Na or NH₄, 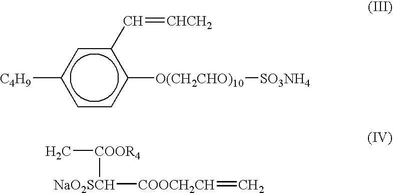
wherein R₄ represents a C₁₂-C₁₈alkyl group, 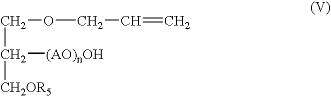
wherein R₅ represents an alkyl group, and AO represents alkyl oxide.

5. The resin composition as claimed in claim 1, wherein the emulsifying agent (C) is a non-reactive emulsifying agent.

6. The resin composition as claimed in claim 5, wherein the non-reactive emulsifying agent is an anionic emulsifying agent.

7. The resin composition as claimed in claim 6, wherein the anionic emulsifying agent is selected from the group consisting of potassium oleate, sodium laurylsulfate, sodium dodecyl benzenesulfonate, sodium alkylnaphthalene sulfonate, sodium dialkyl sulfonate, sodium polyoxyethylene alkyl ether sulfate, sodium polyoxyethylene alkyl allyl ether sulfate, polyoxyethylene alkyl ether phosphate ester, and polyoxyethylene alkyl allyl ether phosphate ester.

8. The resin composition as claimed in claim 5, wherein the non-reactive emulsifying agent is a nonionic emulsifying agent.

9. The resin composition as claimed in claim 8, wherein the nonionic emulsifying agent is selected from the group consisting of polyoxyethylene alkyl ether, polyoxyethylene alkyl allyl ether, polyoxyethylene polyoxypropylene block copolymer, polyoxyethylene glycol fatty acid ester, and polyoxyethylene sorbitan fatty acid ester.

10. The resin composition as claimed in claim 1, wherein the resin composition further comprises an intramolecular cross-linker.

11. The resin composition as claimed in claim 10, wherein the intramolecular cross-linker is present in an amount of from 0.01 to 10 weight parts based on the combined weight parts of the alkyl acrylate, the vinyl unsaturated monomer, and the intramolecular cross-linker.

12. The resin composition as claimed in claim 11, wherein the emulsifying agent is present in an amount of from 0.1 to 10 weight parts based on the combined weight parts of the alkyl acrylate, the vinyl unsaturated monomer, and the intramolecular cross-linker.

13. The resin composition as claimed in claim 10, wherein the intramolecular cross-linker is selected from the group consisting of divinylbenzene, diethylene glycol dimethacrylate, and dipropylene glycol dimethacrylate.

14. The resin composition as claimed in claim 1, wherein the resin composition further comprises a molecular weight adjusting agent.
